(19) United States
(12) Patent Application Publication
(10) Pub. No.: US 2025/0021934 A1
(43) Pub. Date: Jan. 16, 2025

(54) Apparatus comprising a camera arrangement

(71) Applicant: SICK AG, Waldkirch (DE)

(72) Inventors: Frank SCHÜTZ, Rheinhausen (DE); Christopher WEBER, Seelbach (DE)

(21) Appl. No.: 18/770,836

(22) Filed: Jul. 12, 2024

(30) Foreign Application Priority Data
Jul. 13, 2023 (DE) 102023118599.3

(51) Int. Cl. G06Q 10/087; G03B 21/26; G06K 7/10; G06Q 30/0207; G06T 7/70

(52) U.S. Cl. CPC G06Q 10/087; G03B 21/26; G06K 7/10445; G06Q 30/0223; G06T 7/70

(57) ABSTRACT

The invention relates to an apparatus for a logistics center, in particular an industrial goods warehouse, said apparatus comprising a camera arrangement for detecting a plurality of articles placed on a placement surface within the entire field of view of the camera arrangement, a projection device for projecting information relating to the detection, and an electronic control device that is in signal connection with the camera arrangement and the projection device and that is configured to detect the articles individually by means of image analysis, and to display the detection of a picking up of a respective article from the placement surface and/or a placing of a respective article onto the placement surface in a visually recognizable manner by a projection.

The invention relates to an apparatus for a logistics center, in particular an industrial goods warehouse, comprising a camera arrangement for detecting a plurality of articles placed on a placement surface within the entire field of view of the camera arrangement.

In logistics centers, for example, hand scanners are often used to detect articles to be processed. If an article is moved to another location, it is usually registered by means of a hand scanner. As a result, a picking up of an article from a shelf or a placing of an article in a shelf can, for example, be recorded by warehousing software, whereby an electronic tracking for determining a current location of the article is made possible. However, such a procedure requires many hand scanners and a large number of said registration processes. Furthermore, with the known applications, a person moving the article cannot easily recognize whether the picking up or placing was also actually detected correctly.

The invention is therefore based on the object of providing an apparatus that enables a simplified detection of articles and simultaneously enables an increase in the reliability.

This object is satisfied by an apparatus having the features of claim 1, and in particular in that the apparatus comprises a projection device for projecting information relating to the detection and an electronic control device that is in signal connection with the camera arrangement and the projection device. The electronic control device is configured to detect the articles individually by means of image analysis, and to display the detection of a picking up of a respective article from the placement surface and/or a placing of a respective article onto the placement surface in a visually recognizable manner by a projection.

The placement surface can comprise the surfaces of, for example, one or more tables and/or one or more shelves (e.g. a plurality of shelf boards, preferably at different levels) that are suitable for placement. The camera arrangement comprises a plurality of individual cameras and is configured such that the entire field of view of the camera arrangement covers the desired area, depending on the application, and the articles therein. In a very simple version, only one camera would generally also be conceivable, wherein the apparatus should already comprise at least two or three cameras to detect only one article. By using a plurality of cameras, a multitude of independent sensor data can be used for detection, whereby the apparatus according to the invention enables an increase in the reliability of the detection. Since the article no longer has to be registered with a hand scanner, but the picking up and/or placing is automatically detected by means of the camera arrangement, a simplification of the detection is also made possible by the apparatus according to the invention. Advantageously, the numerous cameras that are usually, for example, present in a logistics center anyway for security reasons can be part of the camera arrangement or form it. Since no or only a few additional cameras then need to be installed, the design of the apparatus and thus the detection can be further simplified.

The articles are individually detected by the electronic control device by means of the camera arrangement. The detection of the picking up of the respective article from the placement surface and/or the placing of the respective article onto the placement surface is displayed in a visually recognizable manner by the projection. It is understood that the projection can differ appropriately for the detection of the picking up and placing down. Due to the projection, a person moving the article can immediately visually recognize whether the picking up and/or the placing was also actually detected correctly by the apparatus. If, for example, an article is placed onto the placement surface and no corresponding projection is displayed, it is immediately recognizable that the placing was incorrectly not detected by the apparatus. The incorrect detection is thus directly recognizable and countermeasures can be taken immediately. Only an interaction between the person and the apparatus is therefore ultimately made possible via the projection device and the camera arrangement, whereby the reliability of the apparatus can be increased.

Advantageous embodiments of the invention result from the dependent claims, from the description, and from the Figures.

It can be provided that the projection device, for example through its orientation, and/or the electronic control device is/are configured to display the projection on a surface accessible for the projection within the entire field of view of the camera arrangement. This makes it easy to reliably display the projection within the entire field of view of the camera arrangement. In principle, any surface is accessible for projection if there is nothing located along a connecting line between the surface and the projection device that would prevent the projection from being displayed on the surface. The projection device and/or the electronic control device can also be configured to display the projection on an information label or a price label of an article, in particular of the respective picked-up and/or placed article, within the entire field of view of the camera arrangement. Such labels are usually located in easily visible places, such as on a visible edge of a shelf below the respective article. The display of the projection on such a label is consequently in the direct field of view when picking up and/or placing the article, whereby it can easily be reliably recognized whether the picking up and/or placing was detected correctly or incorrectly. If the picked-up article is not placed where it was picked up, but is placed with another article on the placement surface, the projection can, for example, take place on the label of the other article. For such a case, it can thereby also be reliably recognized in a simple manner whether the placing was detected correctly or incorrectly. Alternatively or additionally, the projection can take place directly on the respective article. Here, too, the display of the projection is in the direct field of view when picking up and/or placing the article, whereby it can be reliably recognized in a simple manner whether the picking up and/or placing was detected correctly or incorrectly.

The projection preferably comprises an image, a sign, a symbol and/or an article designation. For example, the detection of the picking up can be displayed by the projection of a first sign, e.g. a plus sign, and/or the detection of the placing can be displayed by the projection of a second sign, e.g. a minus sign, or vice versa. With the projection, the detection of the picking up and/or placing can thereby be displayed in a simple, intuitive and reliably recognizable manner. Alternatively or additionally, the projection can also be color-coded. For example, the detection of the picking up of the article can be displayed by the projection of the article designation in green. The detection of the placing can be displayed by the projection of the article designation in red. Consequently, it can be reliably recognized by the color coding, on the one hand, whether the picking up or the placing was detected correctly. By means of the displayed article designation, it can furthermore be reliably recognized whether the placing of the actually placed article was also detected correctly or whether the placing of another article was incorrectly detected. This is in particular advantageous if, for example, the picked-up article is not placed where it was picked up, but is placed with another article on the placement surface. Thus, the detection of the picking up and/or placing can also be displayed in a simple, intuitive and reliably recognizable manner by the respective display of the projection.

The electronic control device can preferably be configured to display the projection for a predefined time duration. The time duration is in this respect predefined so that the projection can be recognized within this duration. The projection can hereby be reliably recognized. For example, the time duration can be 3 or 10 seconds.

Furthermore, the projection device can be designed as a laser projector and/or as a video projector. The projection by means of the laser projector is generally clearly recognizable even under unfavorable conditions (for example, in the case of dirt deposits on the projection surface) and on almost all surfaces (i.e. in particular irrespective of the surface material, the surface structure and the reflection behavior of the surface) (provided that the surface is accessible for the projection). Furthermore, the projection can also be displayed in a clearly recognizable manner on distant accessible surfaces by means of the laser projector. By means of the video projector, the projection can be easily displayed in different colors. However, the projection device can also comprise a plurality of laser projectors and/or video projectors. Further surfaces accessible for the projection can hereby be obtained, in particular by appropriately arranging the plurality of laser projectors and/or video projectors. The projection can also be displayed in different colors by using a plurality of laser projectors.

Advantageously, the apparatus has a force sensor arrangement arranged at the placement surface, with which force sensor arrangement the electronic control device is in signal connection. Alternatively or additionally, the apparatus can also comprise an RFID reading device, with which RFID reading device the electronic control device is in signal connection. The electronic control device can be configured to also detect the picking up of the respective article from the placement surface and/or the placing of the respective article onto the placement surface by means of the force sensor arrangement and/or the RFID reading device. Since a multitude of independent sensor data can hereby be used for detection, the reliability of the apparatus can be further increased during the detection. In the case of the RFID reading device, the articles must be provided with corresponding RFID transponders that can be read by the RFID reading device. Articles are typically provided with RFID transponders anyway, in particular to prevent theft. These RFID transponders can advantageously be used for the described detection of the picking up of the respective article from the placement surface and/or of the placing of the respective article onto the placement surface, whereby the detection can be further simplified.

The apparatus is preferably configured as an apparatus arranged in a stationary manner, i.e. permanently installed on a building ceiling of a logistics center, for example. Alternatively or additionally, the projection device can be arranged at a camera of the camera arrangement, in particular formed as a unit with the camera. If the projection device comprises a plurality of laser projectors and/or video projectors, they can, for example, each be arranged at a respective camera of the camera arrangement, in particular formed as a respective unit with the respective camera. The installation effort of the apparatus can hereby be reduced, whereby the design of the apparatus and thus the detection can be further simplified.

The electronic control device can in particular be configured to display a navigation along a path to a respective article in a visually recognizable manner by a projection by means of the projection device. For this purpose, the electronic control device can have a signal input and can be configured to receive information via the signal input about the respective article to which the navigation is to take place. For example, a person, not shown, can select an article which the person would like to locate by means of an application on a mobile end device. The electronic control device can receive the information about the selected article via the signal input. Furthermore, the electronic control device can be configured to access information that relates to the respective placement locations of the articles present within the entire field of view. This information can be retrieved from an external database by the electronic control device, for example. Furthermore, the electronic control device can be configured to recognize, by means of the camera arrangement, the person who has selected the article and wishes to be navigated to it, and thus to recognize the current location of the person. The electronic control device can additionally be configured to recognize the current location of the mobile end device, and thus the location of the person, for example via a GPS location function of said mobile end device. Using the projection device, the electronic control device can navigate the person along a path to the selected article by the projection, for example of one or more arrows. In this respect, the electronic control device can be configured to update the projection by continuously comparing the recognized current location with the placement location of the article. The electronic control device can further be configured to highlight the selected article in a visually recognizable manner by means of the projection device if a location in front of the sought-after article is recognized as the current location, i.e. if the person has reached the placement location of the sought-after article. The highlighting can, for example, take place by a projection in the form of an arrow pointing to the selected article or a circle surrounding it. By means of the described navigation by projection, the apparatus makes it easier and quicker to locate the respective article. It is understood that these embodiments can also be regarded as an independent invention per se.

According to a further aspect, the present invention also relates to an apparatus for a logistics center, in particular an industrial goods warehouse, comprising a camera arrangement for recognizing a person within the entire field of view of the camera arrangement, a projection device for projecting information relating to the recognition, and an electronic control device that is in signal connection with the camera arrangement and the projection device. The electronic control device is configured to recognize the person by means of image analysis and to display a navigation along a path to a respective article of a plurality of articles placed on a placement surface in a visually recognizable manner within the entire field of view of the camera arrangement by means of a projection. The electronic control device has a signal input and is configured to receive information via the signal input about the respective article to which the navigation is to take place. It is understood that this apparatus can also be advantageously further developed by the features of the remaining disclosure.

The electronic control device is preferably configured, for a predetermined time period, to display information about a special offer and/or a discount in a visually recognizable manner on a price label and/or directly on an article by a projection. Up-to-date information relating to the article can thereby be easily displayed. The risk of error due to outdated information relating to the article can thereby also be reduced. Alternatively or additionally, the electronic control device can be configured, for a predetermined time period, to highlight a respective article in a visually recognizable manner by a projection. The highlighting can, for example, take place by a projection in the form of an arrow pointing to the respective article or a circle surrounding it. The apparatus enables a simplified and quick locating of the respective article through the highlighting. In particular, articles of frequently used article types can be highlighted. The apparatus can have an electronic interface and can be configured to receive data required for the projection from an external device, for example a memory device. This may, for example, be data that define the article for which the projection is to be displayed and/or that predetermine the time period of the projection. Furthermore, the data can also relate to the content of the projection, for example the discount. It is understood that these embodiments can also be regarded as an independent invention per se.

According to another aspect, the present invention also relates to an apparatus for a logistics center, in particular an industrial goods warehouse,

comprising a camera arrangement for detecting a plurality of articles placed on a placement surface within the entire field of view of the camera arrangement, a projection device for projecting information relating to the goods, and an electronic control device that is in signal connection with the camera arrangement and the projection device and that is configured to detect the articles individually by means of image analysis and, for a predetermined time period, to display information about a special offer and/or a discount in a visually recognizable manner on a price label and/or directly on an article by a projection and/or to highlight a respective article in a visually recognizable manner by a projection. It is understood that this apparatus can also be advantageously further developed by the features of the remaining disclosure.

According to a further aspect, the invention relates to a method for a logistics center, in particular an industrial goods warehouse, for detecting a plurality of articles placed on a placement surface by means of a camera arrangement within the entire field of view of the camera arrangement and for projecting information relating to the detection by means of a projection device. In the method, the articles are individually detected by means of image analysis. The detection of a picking up of a respective article from the placement surface and/or a placing of a respective article onto the placement surface is displayed in a visually recognizable manner by a projection.

The image analysis can generally take place using the electronic control device according to standard procedures. For this purpose, the electronic control device can, for example, be configured to process the sensor data of the camera arrangement, of the force sensor arrangement and/or of the RFID reading device for detection and/or recognition by means of sensor data fusion and computer vision in conjunction with artificial intelligence.

The statements on the apparatus according to the invention generally apply to the method according to the invention accordingly; this in particular applies with respect to embodiments and advantages. It is furthermore understood that all the features mentioned herein can be combined with one another, unless explicitly stated otherwise.

Furthermore, it is understood that the apparatus according to the invention as well as the method and their embodiments are explained purely by way of example for the use in a logistics center. Their use, for example, in an industrial warehouse, a manufacturing plant or a supermarket, especially one without cash registers, is equally conceivable.

The invention will be described in the following by way of example with reference to the Figures. There are shown as schematic outline sketches

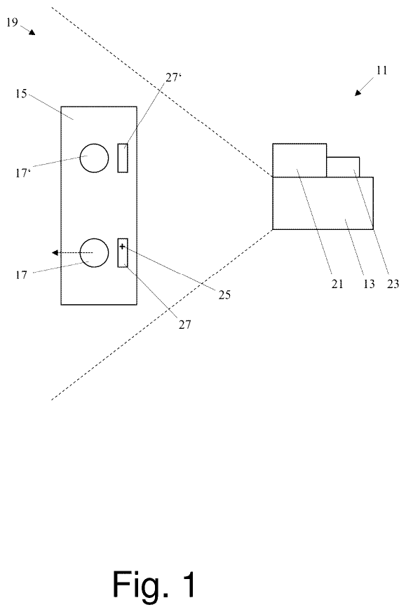

FIG. 1 a first apparatus according to the invention;

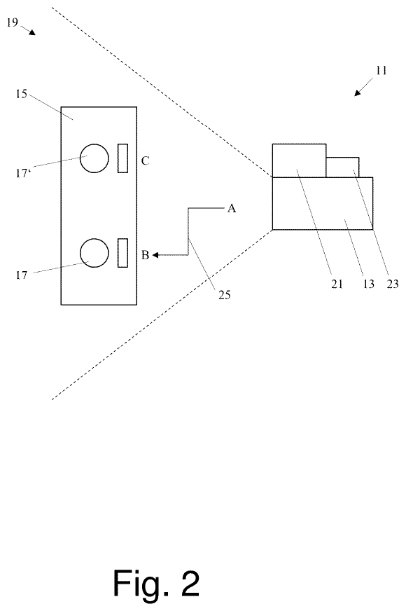

FIG. 2 a second apparatus according to the invention; and

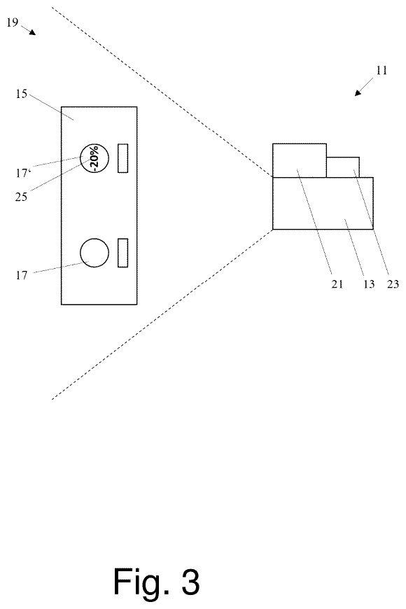

FIG. 3 a third apparatus according to the invention.

FIG. 1 shows a schematic outline sketch of a first apparatus 11 according to the invention for a logistics center. The apparatus 11 comprises a camera arrangement 13 for detecting a plurality of articles 17, 17′ placed on a placement surface 15 of a table within the entire field of view 19 (illustrated by the two dashed lines) of the camera arrangement 13. Furthermore, the apparatus 11 comprises a projection device 21 in the form of a laser projector for projecting information relating to the detection, and an electronic control device 23. The electronic control device 23 is in signal connection with the camera arrangement 13 and the laser projector 21. The signal connection can generally be designed as wired and/or wireless. Furthermore, the electronic control device 23 is configured to detect the articles 17, 17′ individually by means of image analysis and to display the detection of a picking up of a respective article 17, 17′ from the placement surface 15 and a placing of a respective article 17, 17′ onto the placement surface 15 in a visually recognizable manner by a respective projection 25.

In the exemplary embodiment shown, the camera arrangement 13 comprises three individual cameras (not shown). The arrangement and number of the cameras are selected and realized such that the entire field of view 19 of the camera arrangement 13 covers the region illustrated by means of the two dashed lines and the articles 17, 17′ therein. The laser projector 21 is arranged at one of the cameras of the camera arrangement 13 and forms a unit with it, wherein the apparatus 11 is permanently installed at a building ceiling of the logistics center. Furthermore, the laser projector 21 is oriented in such a manner that and the electronic control device 23 is configured to display the projection 25 on a respective information label 27, 27′ of the articles 17, 17′.

The articles 17, 17′ are individually detected by the electronic control device 23 via the camera arrangement 13. A picking up of the article 17 from the placement surface 15 by a person, not shown, is illustrated by way of example by means of the dashed arrow. The picking up of the article 17 is also detected by the electronic control device 23. The electronic control device 23 is configured such that it here displays, by means of the laser projector 21, the projection 25 in the form of a plus sign for a predefined time duration of five seconds on that information label 27, 27′ from which the respective article 17, 17′ is picked up—i.e.

on the information label 27 of the article 17 in the example shown. The display of the plus sign 25 on the information label 27 is in this respect located in the direct field of view of the person when picking up the article 17, whereby the person can reliably recognize in a simple manner whether the picking up was detected correctly or incorrectly. However, if the plus sign 25 was not displayed during the picking up, the person could directly recognize the incorrect detection and immediately take countermeasures.

The electronic control device 23 is further configured such that—for the case not shown in FIG. 1—when the person places the picked-up article 17 on the placement surface 15 again, when detecting the placing, said electronic control device 23 displays the projection in the form of a minus sign, by means of the laser projector 21, for the predefined time duration of five seconds on that information label 27, 27′ to which the article 17 is placed. The display of the minus sign is hereby also in the direct field of view of the person during the placing so that the person can likewise reliably recognize in a simple manner whether the placing was detected correctly or incorrectly.

The apparatus 11 can furthermore have a force sensor arrangement (not shown) arranged at the placement surface 15, with which force sensor arrangement the electronic control device 23 is in signal connection. Alternatively or additionally, the apparatus 11 can also comprise an RFID reading device (not shown), with which RFID reading device the electronic control device 23 is in signal connection. The electronic control device 23 can then be configured to also detect the picking up of the respective article 17, 17′ from the placement surface 15 and/or the placing of the respective article 17, 17′ onto the placement surface 15 by means of the force sensor arrangement and/or the RFID reading device.

FIG. 2 shows a schematic outline sketch of a second apparatus 11 according to the invention that can generally be configured like the apparatus 11 from FIG. 1. The apparatus 11 shown in FIG. 2 comprises a camera arrangement 13 for recognizing a person within the entire field of view 19 of the camera arrangement 13, a projection device 21 in the form of a laser projector for projecting information relating to the recognition, and an electronic control device 23. The electronic control device 23 is in signal connection with the camera arrangement 13 and the projection device 21 and is configured to recognize the person by means of image analysis. The electronic control device 23 is further configured to display a navigation along a path to a respective article 17, 17′ of a plurality of articles 17, 17′ placed on a placement surface 15 in a visually recognizable manner within the entire field of view 19 of the camera arrangement 13 by means of a projection 25 in the form of an arrow. Furthermore, the electronic control device 23 has a signal input (not shown) and is configured to receive information via the signal input about the respective article 17, 17′ to which navigation is to take place.

For example, a person, not shown, can select the article 17 which the person would like to locate by means of an application on a mobile end device (not shown). The electronic control device 23 receives the information about the selected article 17 via the signal input. Furthermore, the electronic control device 23 is configured to access information relating to the respective placement locations B, C of the articles 17, 17′ present within the entire field of view 19. This information can, for example, be retrieved by the electronic control device 23 from an external database (not shown).

Furthermore, the electronic control device 23 is configured to recognize, by means of the camera arrangement 13, the person who has, for example, selected the article 17 and wishes to be navigated to it, and thus to recognize the current location A of the person. The electronic control device can additionally be configured to recognize the current location of the mobile end device, and thus the location A of the person, for example via a GPS location function of said mobile end device.

By means of the laser projector 21, the electronic control device 23 can navigate the person along a path to the selected article 17 by the projection of the arrow 25. In this respect, the electronic control device 23 can be configured to update the display of the arrow 25 by continuously comparing the recognized current location A of the person with the placement location B of the article.

The electronic control device 23 can further be configured to highlight the selected article 17 in a visually recognizable manner by means of the laser projector 21 if a location in front of the sought-after article is recognized as the current location A, i.e. if the person has reached the placement location B of the sought-after article 17. The highlighting can, for example, take place by a projection in the form of an arrow pointing to the selected article 17 or a circle surrounding it.

FIG. 3 shows a schematic outline sketch of a third apparatus 11 according to the invention that can generally be configured like the apparatus 11 from FIG. 1 or 2. The apparatus 11 shown in FIG. 3 comprises a camera arrangement 13 for detecting a plurality of articles 17, 17′ placed on a placement surface 15 within the entire field of view 19 of the camera arrangement 13, a projection device 21 in the form of a video projector for projecting information relating to the articles 17, 17′, and an electronic control device 23. The electronic control device 23 is in signal connection with the camera arrangement 13 and the projection device 21 and is configured to detect the articles 17, 17′ individually by means of image analysis. The electronic control device 23 is further configured, for a predetermined time period, to display information about a discount in a visually recognizable manner directly on the respective article 17, 17′ by a projection 25.

The apparatus has an electronic interface (not shown) and is configured to receive data required for the projection 25 from an external memory device. In this example, the data specify that the projection 25 should display a content of “−20%” on the article 17′ for a time period of eight hours.

### REFERENCE NUMERAL LIST

11 apparatus
13 camera arrangement
15 placement surface
17 article
17′ article
19 field of view
21 projection device
23 control device
25 projection
27 information label
27′ information label

1. An apparatus for a logistics center, said apparatus comprising a camera arrangement for detecting a plurality of articles placed on a placement surface within the entire field of view of the camera arrangement, a projection device for projecting information relating to the detection, and an electronic control device that is in signal connection with the camera arrangement and the projection device and that is configured to detect the articles individually by means of image analysis, and to display the detection of a picking up of a respective article from the placement surface and/or a placing of a respective article onto the placement surface in a visually recognizable manner by a projection.

2. The apparatus according to claim 1, wherein the logistics center is an industrial goods warehouse.

3. The apparatus according to claim 1, wherein at least one of the projection device and the electronic control device is configured to display the projection on a surface accessible for the projection within the entire field of view of the camera arrangement.

4. The apparatus according to claim 3, wherein the surface accessible for the projection is selected from the group of members consisting of an information label of an article, a price label of an article an information label of a respective article, a price label of a respective article, and directly on a respective article.

5. The apparatus according to claim 1, wherein the projection comprises an image, a sign, a symbol and/or an article designation.

6. The apparatus according to claim 1, wherein the projection is color-coded.

7. The apparatus according to claim 1, wherein the electronic control device is configured to display the projection for a predefined time duration.

8. The apparatus according to claim 7, wherein the predefined time duration is three seconds.

9. The apparatus according to claim 1, wherein the projection device is designed as at least one of a laser projector and a video projector.

10. The apparatus according to claim 1, wherein the apparatus has a force sensor arrangement arranged on the placement surface and/or comprises an RFID reading device, with which force sensor arrangement and/or with which RFID reading device the electronic control device is in signal connection, and wherein the electronic control device is configured to detect the picking up of the respective article from the placement surface and/or the placing of the respective article onto the placement surface by means of the force sensor arrangement and/or the RFID reading device.

11. The apparatus according to claim 1, wherein the apparatus is configured as an apparatus arranged in a stationary manner.

12. The apparatus according to claim 1, wherein the projection device is arranged at a camera of the camera arrangement.

13. The apparatus according to claim 12, wherein the projection device is formed as a unit with the camera.

14. The apparatus according to claim 1, wherein the electronic control device is configured to display a navigation along a path to a respective article in a visually recognizable manner by a projection, wherein the electronic control device has a signal input and is configured to receive information via the signal input about the respective article to which the navigation is to take place.

15. The apparatus according to claim 1, wherein the electronic control device is configured, for a predetermined time period, to display information about a special offer and/or a discount in a visually recognizable manner on an information label or a price label and/or directly on an article by a projection and/or to highlight a respective article in a visually recognizable manner by a projection.

16. A method for a logistics center, for detecting a plurality of articles placed on a placement surface by means of a camera arrangement within the entire field of view of the camera arrangement and for projecting information relating to the detection by means of a projection device, wherein the articles are individually detected by means of image analysis, and the detection of a picking up of a respective article from the placement surface and/or a placing of a respective article onto the placement surface is displayed in a visually recognizable manner by a projection.
